(19) United States
(12) Patent Application Publication
(10) Pub. No.: US 2013/0112836 A1
(43) Pub. Date: May 9, 2013

(54) INTERIOR MIRROR MOUNTING ASSEMBLY WITH INTEGRALLY FORMED METALLIC BALL AND ARM

(71) Applicant: MAGNA MIRRORS OF AMERICA, INC., Holland, MI (US)

(72) Inventor: Donald S. Rawlings, Caledonia, MI (US)

(73) Assignee: MAGNA MIRRORS OF AMERICA, INC., Holland, MI (US)

(21) Appl. No.: 13/669,688

(22) Filed: Nov. 6, 2012

Related U.S. Application Data
(60) Provisional application No. 61/556,551, filed on Nov. 7, 2011.

(51) Int. Cl. A47G 1/24; B23P 11/00

(52) U.S. Cl. 248/484; 29/428

(57) ABSTRACT

An interior rearview mirror assembly includes a mirror head and a mounting assembly for adjustably mounting the mirror head at an interior portion of a vehicle. The mounting assembly includes a mounting base that is attachable to an interior portion of the vehicle and a mounting arm adjustably joined to the mounting base via a base joint. The mirror head is pivotally adjustable relative to the mounting arm via a mirror pivot joint. The mounting arm includes an arm portion and a mirror ball portion that are unitarily formed of a metallic material. The mirror ball portion of the mounting arm is pivotally received at a socket element of the mirror head. The mirror head is adjustable about the base and mirror joints to adjust a rearward field of view of a driver of the vehicle when the mirror assembly is normally mounted in the vehicle.

### CROSS REFERENCE TO RELATED APPLICATION

The present application claims the filing benefit of U.S. provisional application Ser. No. 61/556,551, filed Nov. 7, 2011, which is hereby incorporated herein by reference in its entirety.

### FIELD OF THE INVENTION

The present invention relates generally to the field of rearview mirror assemblies for vehicles and, more particularly, to an interior rearview mirror assembly that is adjustably mounted to an interior portion of a vehicle.

### BACKGROUND OF THE INVENTION

It is known to provide a mirror assembly that is adjustably mounted to an interior portion of a vehicle, such as via a double ball pivot or joint mounting configuration where the mirror casing and reflective element are adjusted relative to the interior portion of a vehicle by pivotal movement about the double ball pivot configuration. The mirror casing and reflective element are pivotable about either or both of the ball pivot joints by a user that is adjusting a rearward field of view of the reflective element.

### SUMMARY OF THE INVENTION

The present invention provides an interior rearview mirror assembly adjustably mounted to an interior portion of a vehicle via a double ball pivot joint mounting configuration that allows a user (such as the driver of the vehicle equipped with the mirror assembly) to adjust a rearward field of view of the reflective element via pivotal adjustment of the mirror casing and reflective element about the ball pivot joint or joints. The mirror mounting assembly or configuration includes a unitary or integrally formed metallic mounting arm with a sleeve and a ball member, such that the mounting arm sleeve may pivotally mount or attach to a pivot element of a mounting base portion that attaches to an interior portion of the vehicle and a ball member that is formed as part of the mounting arm sleeve pivotally attaches to a socket element at the mirror head or mirror casing of the interior rearview mirror assembly.

According to an aspect of the present invention, an interior rearview mirror assembly for a vehicle comprises a mirror head having a reflective element, and a mounting assembly or configuration for adjustably mounting the mirror head at an interior portion of a vehicle. The mounting configuration comprises a mounting base that is attachable to an interior portion of a vehicle and a mounting arm adjustably joined to the mounting base via a first pivot joint or base pivot joint, with the mirror head or reflective element adjustably mounted to the mounting arm via a second pivot joint or mirror pivot joint. The mounting arm comprises a unitarily formed sleeve and ball construction where one end of the arm has a ball member formed thereat for pivotally attaching at a socket element of the mirror head or the mounting base. The mirror head and reflective element are adjustable about the pivot joint or joints to adjust a rearward field of view of a driver of a vehicle when the mirror assembly is normally mounted in the vehicle.

Optionally, the mounting arm may comprise a double ball ended arm with a ball member integrally formed at opposite ends of the sleeve portion. Optionally, the mounting arm may comprise a hydroformed arm or a computer numerically controlled (CNC) spun aluminum tube or steel tube or the like.

The unitary mounting arm construction replaces known ball stud and overmolding constructions and processes of typical or conventional mirror mounting assemblies, such as for interior prismatic and/or electrochromic rearview mirror assemblies. Thus, the present invention obviates the die cast zinc (or aluminum or the like) ball stud and overmolding processes. By forming the ball member at the end of the arm or sleeve and forming the sleeve and ball member integrally together, the present invention avoids or obviates the friction cup on the mirror end of the mounting assembly. Also, by providing the ball member at the mirror end of the mounting arm (and integrally forming the ball member with the mounting arm), the present invention provides a “ball in” mirror mounting construction with the ball received in a socket element of the mirror head and thus moving the pivot point closer to the center of gravity of the mirror head and, thus, improving vibration performance of the mirror assembly.

These and other objects, advantages, purposes and features of the present invention will become apparent upon review of the following specification in conjunction with the drawings.

### BRIEF DESCRIPTION OF THE DRAWINGS

FIG. 1 is a perspective view of an interior rearview mirror assembly and mounting assembly in accordance with the present invention;

FIG. 2 is a partially exploded side elevation of the mounting assembly of the interior rearview mirror assembly of FIG. 1;

FIG. 3 is a side elevation of the unitary metallic mounting arm sleeve and ball member of the present invention;

FIG. 4 is an end elevation of the unitary mounting arm of FIG. 3; and

FIG. 5 is a side elevation of another unitary metallic mounting arm sleeve and ball member of the present invention, having a ball member integrally formed at each end of the mounting arm or sleeve.

### DESCRIPTION OF THE PREFERRED EMBODIMENTS

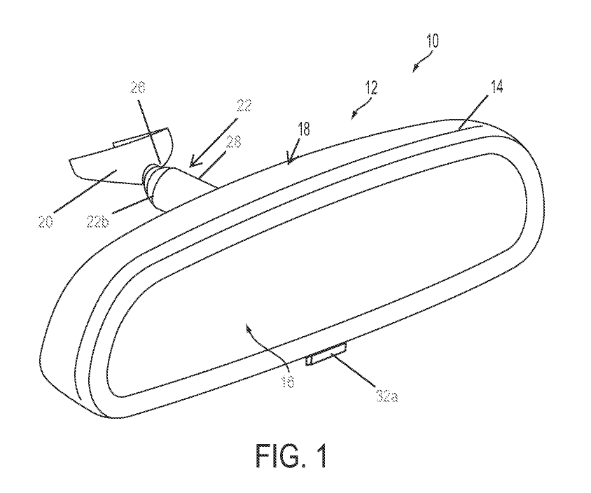

Referring now to the drawings and the illustrative embodiments depicted therein, an interior rearview mirror assembly 10 for a vehicle includes a mirror head 12, which includes a casing and/or bezel portion 14 and a reflective element 16 positioned at and at least partially within the casing and/or bezel portion, and includes a mounting assembly or configuration 18, which pivotally mounts the mirror head 12 to an interior portion of a vehicle (FIG. 1). Mirror assembly 10 is adjustably mounted to an interior portion of a vehicle (such as to an interior surface of a vehicle windshield or a headliner of a vehicle or the like) via a double ball pivot mounting configuration or assembly 18. Mounting assembly 18 includes a base portion or mounting base or breakaway stay 20 and a mounting arm 22, with the reflective element 16 and/or mirror head 12 pivotally mounted at an outer or rearward or mirror or ball end 22a of mounting arm 22 about a first or mirror ball pivot joint 24 (such as a ball and socket joint or the like that allows for a driver of the vehicle to which mirror assembly 10 is mounted to adjust the reflective element vertically and horizontally to adjust the rearward field of view of the driver). The opposite or forward or base end 22b of mounting arm 22 is adjustably mounted to mounting base 20 about a second or adjustable or base joint 26 (which may have a greater resistance to pivotal movement of the arm relative to the base portion than the resistance to pivotal movement provided at the pivot joint 24). The mounting arm 22 comprises a metallic mounting arm that has a unitarily formed or integrally formed sleeve 28 and ball member 30, such that the ball member 30 is formed with and as part of the sleeve 28, as discussed below.

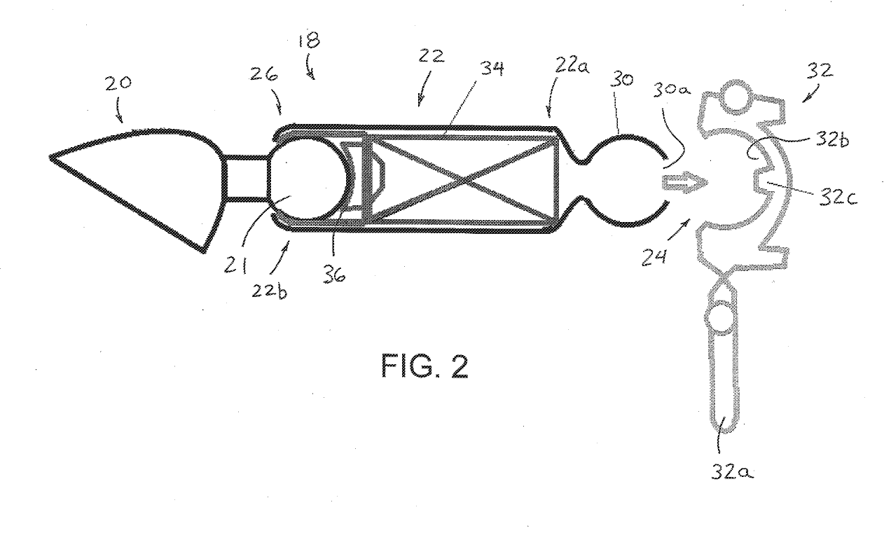

In the illustrated embodiment, mounting base 20 is configured to attach to an interior surface of a vehicle windshield (such as to a mounting button or attachment element adhered to the interior surface of the vehicle windshield, such as by utilizing aspects of the mounting systems described in U.S. Pat. No. 5,587,236 and/or U.S. patent application Ser. No. 13/151,602, filed Jun. 2, 2011 (Attorney Docket DON01 P-1711), which are hereby incorporated herein by reference in their entireties) and extends downwardly from the attachment location. The mounting base may be mounted to a mounting button or attachment element at the vehicle windshield via a breakaway mounting construction, such as by utilizing aspects of the mounting constructions described in U.S. Pat. Nos. 5,820,097 and/or 5,100,095, which are hereby incorporated herein by reference in their entireties. The base portion 20 may comprise any suitable base portion and may be a molded (such as injection molded) polymeric component or may be otherwise formed, depending on the particular application of the mirror assembly (and may utilize aspects of the mounting assemblies described in U.S. Pat. Nos. 6,318,870; 6,593,565; 6,690,268; 6,540,193; 4,936,533; 5,820,097; 5,100,095; 7,249,860; 6,877,709; 6,329,925; 7,289,037; 7,249,860; and/or 6,483,438, and/or U.S. patent application Ser. No. 11/226,628, filed Sep. 14, 2005 and published Mar. 23, 2006 as U.S. Publication No. US-2006-0061008, which are hereby incorporated herein by reference in their entireties). The mounting base 20 may, such as shown in FIG. 2, include a ball member 21 extending from the base portion that attaches at the vehicle windshield.

As shown in FIG. 2, the mirror head may comprise or house or support a prismatic reflective element 16, and includes a toggle assembly 32, with a toggle or tab 32a that a user may move or actuate to pivot the mirror head and reflective element between a daytime reflectance orientation and a nighttime, reduced reflectance orientation. The toggle assembly may comprise any suitable toggle assembly (and may utilize aspects of the toggle assemblies described in U.S. Pat. Nos. 6,318,870 and/or 7,249,860, and/or U.S. patent application Ser. No. 12/558,892, filed Sep. 14, 2009 and published Apr. 8, 2010 as U.S. Publication No. US-2010-0085653, which are hereby incorporated herein by reference in their entireties). Toggle assembly 32 comprises a socket portion or element 32b configured for receiving ball member 30 of mounting arm 22, and may include a tab or pin 32c that may be received in a hollow opening 30a at the end of ball member 30 to limit pivotal movement and/or separation under impact of toggle assembly 32 relative to ball member 30.

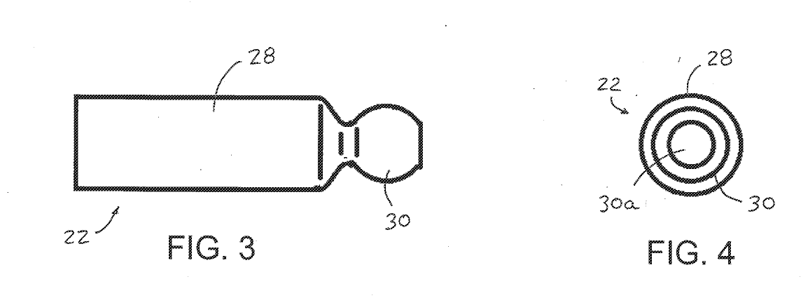

As shown in FIGS. 2-3, mounting arm 22 comprises a single unitary construction comprising a hollow tube or sleeve portion 28 and a hollow ball member 30. Mounting arm 22 comprises a metallic material and may be formed via any suitable forming means, such as via a hydroforming process that forms the hollow tube and ball, or such as via a computer numerically controlled (CNC) spun tube (such as an aluminum tube or a steel tube or the like) that is formed to the desired shape and dimensions, or the like. As shown in FIGS. 2 and 3, the unitary arm 22 comprises a hollow sleeve portion 28 that may receive a biasing element or spring 34 and a socket element 36 therein, whereby the ball member 21 of base portion 20 is pivotally received in the socket element 36 to pivotally mount or attach the mounting arm 22 to the base portion 20. The end 22b of the arm 22 may be swaged (such as via any suitable swaging process, and such as after the ball member 21 is received in socket 36 and sleeve 28) to narrow the opening at that end to limit or substantially preclude retraction of the ball member 21 and/or socket element 36 from the mounting arm 22 after the mounting arm and base portion have been assembled together.

In the illustrated embodiment, ball member 28 of mounting arm 22 comprises a generally spherical or partially spherical ball member that is received in a socket 32b of toggle element 32 of mirror head or casing 12 and/or at the rear of the reflective element 16. Mounting arm 22 may comprise any suitable material, such as a suitable metallic material, such as aluminum or steel or the like (and the mounting assembly may utilize aspects of the mounting assemblies described in U.S. Pat. Nos. 6,318,870; 6,593,565; 6,690,268; 6,540,193; 4,936,533; 5,820,097; 5,100,095; 7,249,860; 6,877,709; 6,329,925; 7,289,037; 7,249,860; and/or 6,483,438, and/or U.S. patent application Ser. No. 11/226,628, filed Sep. 14, 2005 and published Mar. 23, 2006 as U.S. Publication No. US-2006-0061008, which are hereby incorporated herein by reference in their entireties). Optionally, the hollow mounting arm may be used to route or conceal electrical wiring that may pass through and along the mounting arm from the base portion to the mirror head, in order to electrically connect a vehicle wiring harness to circuitry in the mirror head.

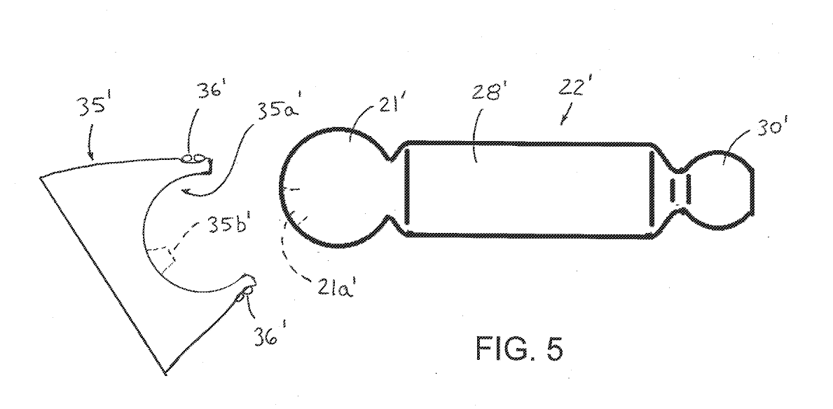

Optionally, and with reference to FIG. 5, the mounting arm 22′ may comprise a double ball or double ball ended metallic mounting arm, with ball member 30′ at one end of sleeve 28′ and with another ball member 21′ established at the opposite end of sleeve 28′, and with the sleeve 28′ and ball members 30′, 21′ being unitarily formed together (such as via any suitable means, such as via a hydroforming process that forms the hollow tube and ball members, or such as via a spun tube, such as a computer numerical control (CNC) spun tube (such as an aluminum tube or steel tube or the like) that is formed to the desired shape and dimensions, or the like). Thus, ball member 28′ would pivotally attach at the mirror head in a similar manner as discussed above, while ball member 21′ would pivotally attach to a socket element of a mounting or base portion 35′ to pivotally attach the mounting arm at the mounting base portion (which is configured to attach to an interior portion of a vehicle via any suitable manner). The unitarily formed double ball ended mounting arm 22′ thus obviates the internal spring and socket elements of mounting arm 22, discussed above. Optionally, the mounting portion 35′, which has a socket or receiving portion 35a′ that is configured for receiving ball member 21′ of mounting arm 22′, may include a tab or pin 35b′ that may be received in a hollow opening 21a′ at the end of ball member 21′ to limit pivotal movement and/or separation under impact of ball member 21′ at the socket 35a′ of mounting portion 35′.

Therefore, the present invention provides a unitary construction of a mounting sleeve and ball member, with the mounting sleeve and ball member construction comprising a metallic material. By forming the ball at the end of the sleeve and as part of the sleeve, the present invention eliminates the die cast zinc or aluminum ball stud and overmolding process and eliminates the overmolded (friction) cup at the mirror end of the mounting arm. The torque at the pivot joints (that is required to overcome the frictional fit at the joints to pivot the mirror head and reflective element to adjust the rearward field of view) is controlled by the interference fit of the formed metallic ball in the ball socket of the mirror head or toggle device, which may comprise a molded polypropylene material or the like or other suitable plastic or polymeric material and may be further stabilized by the addition of an annular spring 36′ (shown in FIG. 5 as being disposed at the mounting portion, but it is envisioned that such a spring is suitable for use at a toggle device). Also, because the ball member is part of the mirror end of the mounting arm and the mounting arm does not receive a ball member at the mirror end, the ball member extends into the mirror head and the pivot joint is established further into the mirror head and thus closer to the center of gravity of the mirror head, which may provide a reduction in vibration and thus enhanced vibration performance of the mirror head.

In the illustrated embodiments, the interior rearview mirror assembly comprises a prismatic mirror assembly. For example, the interior rearview mirror assembly may comprise a prismatic mirror assembly such as of the types described in U.S. Pat. Nos. 7,249,860; 6,318,870; 6,598,980; 5,327,288; 4,948,242; 4,826,289; 4,436,371; and 4,435,042; and PCT Application No. PCT/US2004/015424, filed May 18, 2004 and published on Dec. 2, 2004, as International Publication No. WO 2004/103772, which are hereby incorporated herein by reference in their entireties. Optionally, the prismatic reflective element may comprise a conventional prismatic reflective element or prism or may comprise a prismatic reflective element of the types described in U.S. Pat. Nos. 7,420,756; 7,274,501; 7,249,860; 7,338,177; and/or 7,255,451, and/or PCT Application No. PCT/US03/29776, filed Sep. 19, 2003 and published Apr. 1, 2004 as International Publication No. WO 2004/026633; and/or PCT Application No. PCT/US2004/015424, filed May 18, 2004 and published on Dec. 2, 2004, as International Publication No. WO 2004/103772; and U.S. provisional application, Ser. No. 60/525,952, filed Nov. 26, 2003, which are all hereby incorporated herein by reference in their entireties, without affecting the scope of the present invention. A variety of mirror accessories and constructions are known in the art, such as those disclosed in U.S. Pat. Nos. 5,555,136; 5,582,383; 5,680,263; 5,984,482; 6,227,675; 6,229,319; and 6,315,421 (the entire disclosures of which are hereby incorporated by reference herein), that can benefit from the present invention.

Although shown and described as comprising a prismatic mirror reflective element, the mounting assembly of the present invention may be used in conjunction with an electro-optic or electrochromic mirror assembly that includes an electro-optic or electrochromic reflective element. The electrochromic mirror element of the electrochromic mirror assembly may utilize the principles disclosed in commonly assigned U.S. Pat. Nos. 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,117,346; 5,724,187; 5,668,663; 5,910,854; 5,142,407 and/or 4,712,879, which are hereby incorporated herein by reference in their entireties, and/or as disclosed in the following publications: N. R. Lynam, “Electrochromic Automotive Day/Night Mirrors”, SAE Technical Paper Series 870636 (1987); N. R. Lynam, “Smart Windows for Automobiles”, SAE Technical Paper Series 900419 (1990); N. R. Lynam and A. Agrawal, “Automotive Applications of Chromogenic Materials”, Large Area Chromogenics: Materials and Devices for Transmittance Control, C. M. Lampert and C. G. Granquist, EDS., Optical Engineering Press, Wash. (1990), which are hereby incorporated by reference herein in their entireties; and/or as described in U.S. Pat. No. 7,195,381, which is hereby incorporated herein by reference in its entirety.

Optionally, the mirror assembly may include a circuit element (such as a printed circuit board or the like) with circuitry established thereat for powering and/or controlling one or more electronic features or accessories associated with the mirror assembly. For example, the reflective element may comprise an electro-optic mirror reflective element, such as an electrochromic mirror reflective element or cell, and the circuit element may include terminals or connectors for electrically connecting to electrode clips or the like at the conductive surfaces of the reflective element via electrically conductive wires or leads, such as in a known manner or such as by utilizing aspects of the mirror assemblies described in U.S. Pat. Nos. 7,274,501; 7,255,451; 7,195,381; 7,184,190; 5,668,663; 5,724,187 and/or 6,690,268, and/or U.S. patent applications, Ser. No. 11/226,628, filed Sep. 14, 2005 and published Mar. 23, 2006 as U.S. Publication No. US-2006-0061008; Ser. No. 10/538,724, filed Jun. 13, 2005 and published Mar. 9, 2006 as U.S. Publication No. US-2006-0050018; Ser. No. 12/578,732, filed Oct. 14, 2009 (Attorney Docket DON01 P-1564); and/or Ser. No. 12/576,550, filed Oct. 12, 2009 (Attorney Docket DON01 P-1562), and/or PCT Application No. PCT/US2010/029173, filed Mar. 30, 2010 and published on Oct. 7, 2010 as International Publication No. WO 2010/114825, and/or PCT Application No. PCT/US03/29776, filed Sep. 9, 2003 and published Apr. 1, 2004 as International Publication No. WO 2004/026633, which are all hereby incorporated herein by reference in their entireties.

Optionally, the mirror assembly may include one or more displays, such as the types disclosed in U.S. Pat. Nos. 5,530,240 and/or 6,329,925, which are hereby incorporated herein by reference in their entireties, and/or display-on-demand transflective type displays, such as the types disclosed in U.S. Pat. Nos. 7,881,496; 7,855,755; 7,274,501; 7,255,451; 7,195,381; 7,184,190; 5,668,663; 5,724,187 and/or 6,690,268, and/or in U.S. patent applications, Ser. No. 11/226,628, filed Sep. 14, 2005 and published Mar. 23, 2006 as U.S. Publication No. US-2006-0061008; and/or Ser. No. 10/538,724, filed Jun. 13, 2005 and published Mar. 9, 2006 as U.S. Publication No. US-2006-0050018, and/or PCT Application No. PCT/US03/29776, filed Sep. 9, 2003 and published Apr. 1, 2004 as International Publication No. WO 2004/026633, which are all hereby incorporated herein by reference in their entireties.

The interior rearview mirror assembly may include a bezel portion and casing, such as described above, or the mirror assembly may comprise other types of casings or bezel portions or the like, such as described in U.S. Pat. Nos. 7,249,860; 6,439,755; 4,826,289; and 6,501,387; and/or PCT Application No. PCT/US2004/015424, filed May 18, 2004 and published on Dec. 2, 2004, as International Publication No. WO 2004/103772; and/or U.S. patent applications, and/or Ser. No. 10/993,302, filed Nov. 19, 2004; and/or U.S. provisional application, Ser. No. 60/525,952, filed Nov. 26, 2003, which are all hereby incorporated herein by reference in their entireties, without affecting the scope of the present invention. For example, the mirror assembly may comprise a flush or frameless or bezelless reflective element, such as the types described in U.S. Pat. Nos. 7,626,749; 7,360,932; 7,255,451; 7,274,501; and/or 7,184,190, and/or in PCT Application No. PCT/US2004/015424, filed May 18, 2004 and published on Dec. 2, 2004, as International Publication No. WO 2004/103772; PCT Application No. PCT/US03/35381, filed Nov. 5, 2003 and published May 21, 2004 as International Publication No. WO 2004/042457; and/or in U.S. patent applications, Ser. No. 11/226,628, filed Sep. 14, 2005 and published Mar. 23, 2006 as U.S. Publication No. US-2006-0061008; and/or Ser. No. 10/538,724, filed Jun. 13, 2005 and published Mar. 9, 2006 as U.S. Publication No. US-2006-0050018, and/or U.S. Des. Pat. Nos. D633,423; D633,019; D638,761; and/or D647,017, and/or PCT Application No. PCT/US2010/032017, filed Apr. 22, 2010 and published on Oct. 28, 2010 as International Publication No. WO 2010/124064, and/or PCT Application No. PCT/US10/51741, filed Oct. 7, 2010 and published on Apr. 14, 2011 as International Publication No. WO 2011/044312, and/or PCT Application No. PCT/US2011/056295, filed Oct. 14, 2011 and published on Apr. 19, 2012 as International Publication No. WO 2012/051500, which are all hereby incorporated herein by reference in their entireties.

Optionally, the mirror assembly and/or prismatic or electrochromic reflective element may include one or more displays, such as for the accessories or circuitry described herein. The displays may be of types disclosed in U.S. Pat. Nos. 5,530,240 and/or 6,329,925, which are hereby incorporated herein by reference in their entireties, and/or may be display-on-demand or transflective type displays, such as the types disclosed in U.S. Pat. Nos. 7,338,177; 7,195,381; 6,690,298; 5,668,663 and/or 5,724,187, and/or in U.S. patent applications, Ser. No. 11/226,628, filed Sep. 14, 2005 and published Mar. 23, 2006 as U.S. Publication No. US-2006-0061008, and/or in PCT Application No. PCT/US03/29776, filed Sep. 19, 2003 and published Apr. 1, 2004 as International Publication No. WO 2004/026633, which are all hereby incorporated herein by reference in their entireties.

Such a video display screen device or module may comprise any type of video screen and is operable to display images in response to an input or signal from a control or imaging system. For example, the video display screen may comprise a multi-pixel liquid crystal module (LCM) or liquid crystal display (LCD), preferably a thin film transistor (TFT) multi-pixel liquid crystal display (such as discussed below), or the screen may comprise a multi-pixel organic electroluminescent display or a multi-pixel light emitting diode (LED), such as an organic light emitting diode (OLED) or inorganic light emitting diode display or the like, or a passive reflective and/or backlit pixelated display, or an electroluminescent (EL) display, or a vacuum fluorescent (VF) display or the like. For example, the video display screen may comprise a video screen of the types disclosed in U.S. Pat. Nos. 7,855,755; 7,370,983; 7,338,177; 7,274,501; 7,255,451; 7,195,381; 7,184,190; 6,902,284; 6,690,268; 6,428,172; 6,420,975; 5,668,663; 5,724,187; 5,416,313; 5,285,060; 5,193,029 and/or 4,793,690, and/or U.S. patent applications, Ser. No. 10/538,724, filed Jun. 13, 2005 and published Mar. 9, 2006 as U.S. Publication No. US-2006-0050018; Ser. No. 11/226,628, filed Sep. 14, 2005 and published Mar. 23, 2006 as U.S. Publication No. US-2006-0061008; Ser. No. 10/207,291, filed Jul. 29, 2002 and published Jan. 9, 2003 as U.S. Publication No. US 2003-0007261, which are hereby incorporated herein by reference in their entireties.

The video display screen may be controlled or operable in response to an input or signal, such as a signal received from one or more cameras or image sensors of the vehicle, such as a video camera or sensor, such as a CMOS imaging array sensor, a CCD sensor or the like, such as the types disclosed in U.S. Pat. Nos. 5,550,677; 5,760,962; 6,396,397; 6,097,023; 5,877,897; and 5,796,094, and/or U.S. patent application Ser. No. 10/534,632, filed May 11, 2005, which are hereby incorporated herein by reference in their entireties, or from one or more imaging systems of the vehicle, such as a reverse or backup aid system, such as a rearwardly directed vehicle vision system utilizing principles disclosed in U.S. Pat. Nos. 5,550,677; 5,760,962; 5,670,935; 6,201,642; 6,396,397; 6,498,620; 6,717,610 and/or 6,757,109, which are hereby incorporated herein by reference in their entireties, a trailer hitching aid or tow check system, such as the type disclosed in U.S. Pat. No. 7,005,974, which is hereby incorporated herein by reference in its entirety, a cabin viewing or monitoring device or system, such as a baby viewing or rear seat viewing camera or device or system or the like, such as disclosed in U.S. Pat. Nos. 5,877,897 and/or 6,690,268, which are hereby incorporated herein by reference in their entireties, a video communication device or system, such as disclosed in U.S. Pat. No. 6,690,268, which is hereby incorporated herein by reference in its entirety, and/or the like. The imaging sensor or camera may be activated and the display screen may be activated in response to the vehicle shifting into reverse, such that the display screen is viewable by the driver and is displaying an image of the rearward scene while the driver is reversing the vehicle.

Optionally, the mirror assembly may include or may be associated with a compass sensor and circuitry for a compass system that detects and displays the vehicle directional heading to a driver of the vehicle, such as utilizing principles described in U.S. Pat. Nos. 7,329,013 and/or 7,370,983, and/or U.S. patent applications, Ser. No. 11/226,628, filed Sep. 14, 2005 and published Mar. 23, 2006 as U.S. Publication No. US-2006-0061008; and/or Ser. No. 12/578,732, filed Oct. 14, 2009 (Attorney DON01 P-1564), which are hereby incorporated herein by reference in their entireties, and/or such as by utilizing aspects of an EC driver-on-a-chip such as described in U.S. Pat. No. 7,480,149, which is hereby incorporated herein by reference in its entirety. Optionally, a wire management system may include a wire management element or channel or cover element, such as by utilizing aspects of the wire management systems or elements described in U.S. patent application Ser. No. 11/226,628, filed Sep. 14, 2005 and published Mar. 23, 2006 as U.S. Publication No. US-2006-0061008, and/or U.S. Pat. No. 7,510,287, which are hereby incorporated herein by reference in their entireties. The compass chip may be in communication with a compass display, which may utilize aspects of the systems described in U.S. Pat. Nos. 7,195,381; 6,690,268; 5,668,663 5,724,187; 4,882,565; and/or 7,004,593, which are hereby incorporated by reference herein in their entireties. Optionally, the compass system and compass circuitry may utilize aspects of the compass systems described in U.S. Pat. Nos. 7,370,983; 7,249,860; 7,004,593; 6,928,366; 6,642,851; 6,140,933; 4,546,551; 5,699,044; 4,953,305; 5,255,442; 5,576,687; 5,632,092; 5,677,851; 5,708,410; 5,737,226; 5,802,727; 5,878,370; 6,087,953; 6,173,501; 6,222,460; 6,427,349; 6,278,271; 5,942,895; 6,184,679; 5,924,212; 4,862,594; 4,937,945; 5,131,154; 5,255,442; 5,632,092; and/or 6,513,252, and/or European patent application, published Oct. 11, 2000 under Publication No. EP 0 1043566, and/or PCT Application No. PCT/US2004/015424, filed May 18, 2004 and published on Dec. 2, 2004, as International Publication No. WO 2004/103772, and/or International Publication No. WO 2004/076971, published Sep. 10, 2004, which are all hereby incorporated herein by reference in their entireties.

Optionally, the user inputs of the mirror assembly may comprise other types of buttons or switches for controlling or activating/deactivating one or more electrical accessories or devices of or associated with the mirror assembly. The mirror assembly may comprise any type of switches or buttons, such as touch or proximity sensing switches, such as touch or proximity switches of the types described above, or the inputs may comprise other types of buttons or switches or sensors or touch sensor or proximity sensors or the like, such as those described in U.S. Pat. Nos. 7,253,723; and 7,360,932, and/or U.S. patent application Ser. No. 12/576,550, filed Oct. 9, 2009 (Attorney Docket DON01 P-1562), and/or PCT Application No. PCT/US2011/056295, filed Oct. 14, 2011 and published on Apr. 19, 2012 as International Publication No. WO 2012/051500, which are hereby incorporated herein by reference in their entireties.

Optionally, the user inputs or buttons may comprise user inputs for a garage door opening system, such as a vehicle based garage door opening system of the types described in U.S. Pat. Nos. 6,396,408; 6,362,771; 7,023,322; and 5,798,688, and/or U.S. provisional applications, Ser. No. 60/502,806, filed Sep. 12, 2003; and Ser. No. 60/444,726, filed Feb. 4, 2003, which are hereby incorporated herein by reference in their entireties. Optionally, the user inputs may also or otherwise comprise user inputs for a telematics system of the vehicle, such as, for example, an ONSTAR® system as found in General Motors vehicles and/or such as described in U.S. Pat. Nos. 4,862,594; 4,937,945; 5,131,154; 5,255,442; 5,632,092; 5,798,688; 5,971,552; 5,924,212; 6,243,003; 6,278,377; and 6,420,975; 6,477,464; 6,946,978; 7,308,341; 7,167,796; 7,004,593; and/or 6,678,614, and/or PCT Application No. PCT/US03/40611, filed Dec. 19, 2003 and published Jul. 15, 2004 as International Publication No. WO 2004/058540, and/or PCT Application No. PCT/US03/308877, filed Oct. 1, 2003 and published Apr. 15, 2004 as International Publication No. WO 2004/032568, which are all hereby incorporated herein by reference in their entireties.

Optionally, the mirror assembly may include one or more other accessories at or within the mirror casing, such as one or more electrical or electronic devices or accessories, such as antennas, including global positioning system (GPS) or cellular phone antennas, such as disclosed in U.S. Pat. No. 5,971,552, a communication module, such as disclosed in U.S. Pat. No. 5,798,688, a blind spot detection system, such as disclosed in U.S. Pat. Nos. 5,929,786 and/or 5,786,772, transmitters and/or receivers, such as a garage door opener or the like, a digital network, such as described in U.S. Pat. No. 5,798,575, a high/low headlamp controller, such as disclosed in U.S. Pat. Nos. 5,796,094 and/or 5,715,093, a memory mirror system, such as disclosed in U.S. Pat. No. 5,796,176, a hands-free phone attachment, a video device for internal cabin surveillance and/or video telephone function, such as disclosed in U.S. Pat. Nos. 5,760,962 and/or 5,877,897, a remote keyless entry receiver, lights, such as map reading lights or one or more other lights or illumination sources, such as disclosed in U.S. Pat. Nos. 6,690,268; 5,938,321; 5,813,745; 5,820,245; 5,673,994; 5,649,756; 5,178,448; 5,671,996; 4,646,210; 4,733,336; 4,807,096; 6,042,253; 5,669,698; 7,195,381; 6,971,775; and/or 7,249,860, microphones, such as disclosed in U.S. Pat. Nos. 7,657,052; 6,243,003; 6,278,377; and/or 6,420,975, speakers, antennas, including global positioning system (GPS) or cellular phone antennas, such as disclosed in U.S. Pat. No. 5,971,552, a communication module, such as disclosed in U.S. Pat. No. 5,798,688, a voice recorder, a blind spot detection system, such as disclosed in U.S. Pat. Nos. 5,929,786; 5,786,772; 7,038,577; and/or 6,882,287, transmitters and/or receivers, such as for a garage door opener or a vehicle door unlocking system or the like (such as a remote keyless entry system), a digital network, such as described in U.S. Pat. No. 5,798,575, a high/low headlamp controller, such as a camera-based headlamp control, such as disclosed in U.S. Pat. Nos. 5,796,094 and/or 5,715,093, a memory mirror system, such as disclosed in U.S. Pat. No. 5,796,176, a hands-free phone attachment, an imaging system or components or circuitry or display thereof, such as an imaging and/or display system of the types described in U.S. Pat. Nos. 7,855,755; 6,690,268 and 6,847,487, a video device for internal cabin surveillance (such as for sleep detection or driver drowsiness detection or the like) and/or video telephone function, such as disclosed in U.S. Pat. Nos. 5,760,962 and/or 5,877,897, a remote keyless entry receiver, a seat occupancy detector, a remote starter control, a yaw sensor, a clock, a carbon monoxide detector, status displays, such as displays that display a status of a door of the vehicle, a transmission selection (4wd/2wd or traction control (TCS) or the like), an antilock braking system, a road condition (that may warn the driver of icy road conditions) and/or the like, a trip computer, a tire pressure monitoring system (TPMS) receiver (such as described in U.S. Pat. Nos. 6,124,647; 6,294,989; 6,445,287; 6,472,979; 6,731,205; and/or 7,423,522), and/or an ONSTAR® system, a compass, such as disclosed in U.S. Pat. Nos. 5,924,212; 4,862,594; 4,937,945; 5,131,154; 5,255,442; and/or 5,632,092, and/or any other accessory or circuitry or the like (with all of the above-referenced patents and PCT and U.S. patent applications being commonly assigned, and with the disclosures of the referenced patents and patent applications being hereby incorporated herein by reference in their entireties).

Optionally, the mirror assembly (such as at the mounting base, which may be fixed relative to the vehicle windshield) may include an imaging sensor (such as a forward facing imaging sensor or camera that has a forward field of view through the vehicle windshield) that may be part of or may provide an image output for a vehicle vision system, such as a headlamp control system or lane departure warning system or object detection system or other vehicle vision system or the like, and may utilize aspects of various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 5,715,093; 5,877,897; 6,922,292; 6,757,109; 6,717,610; 6,590,719; 6,201,642; 6,498,620; 5,796,094; 6,097,023; 6,320,176; 6,559,435; 6,831,261; 6,806,452; 6,396,397; 6,822,563; 6,946,978; 7,038,577; and 7,004,606; and/or U.S. patent applications, Ser. No. 11/315,675, filed Dec. 22, 2005 and published Aug. 17, 2006 as U.S. Patent Publication No. US-2006-0184297; Ser. No. 10/534,632, filed May 11, 2005 and published Aug. 3, 2006 as U.S. Patent Publication No. US-2006-0171704; Ser. No. 12/091,359, filed Jun. 10, 2008; and/or Ser. No. 12/377,054, filed Feb. 10, 2009; and/or PCT Application No. PCT/US2006/041709 filed Oct. 27, 2006 and published May 10, 2007 as International Publication No. WO 07/053404; and/or PCT Application No. PCT/US2007/75702, filed Aug. 10, 2007 and published Feb. 28, 2008 as International Publication No. WO 08/024639, which are all hereby incorporated herein by reference in their entireties. The sensor may include a lens element or optic between the imaging plane of the imaging sensor and the forward scene to substantially focus the scene at an image plane of the imaging sensor. The imaging sensor may comprise an image sensing module or the like, and may utilize aspects described in U.S. patent application Ser. No. 10/534,632, filed May 11, 2005; and/or PCT Application No. PCT/US2006/041709, filed Oct. 27, 2006 and published May 10, 2007 as International Publication No. WO 07/053404; and/or PCT Application No. PCT/US2003/036177 filed Nov. 14, 2003 and published Jun. 3, 2004 as International Publication No. WO 2004/047421, which are hereby incorporated herein by reference in their entireties.

Optionally, the accessory or accessories, such as those described above and/or below, may be positioned at or within the mirror casing and may be included on or integrated in a printed circuit board positioned within the mirror casing, such as along a rear surface of the reflective element or elsewhere within a cavity defined by the casing, without affecting the scope of the present invention. The user actuatable inputs and/or touch sensors and/or proximity sensors and displays described above may be actuatable to control and/or adjust the accessories of the mirror assembly/system and/or overhead console and/or accessory module and/or vehicle. The connection or link between the controls and the display screen device and/or the navigation system and/or other systems and accessories of the mirror system may be provided via vehicle electronic or communication systems and the like, and may be connected via various protocols or nodes, such as BLUETOOTH®, SCP, UBP, J1850, CAN J2284, Fire Wire 1394, MOST, LIN, FlexRay™, Byte Flight and/or the like, or other vehicle-based or in-vehicle communication links or systems (such as WIFI and/or IRDA) and/or the like, or via VHF or UHF or other wireless transmission formats, depending on the particular application of the mirror/accessory system and the vehicle. Optionally, the connections or links may be provided via various wireless connectivity or links, without affecting the scope of the present invention.

Optionally, the mounting assembly of the present invention may be utilized in conjunction with an accessory module or windshield electronics module or the like, and the mirror assembly may mount to the module (such as to a mirror mounting button at the rear surface of the accessory module with the angle of the mounting button being adjusted and selected and set by the adjustable mounting assembly of the accessory module). The accessory module or windshield electronics module may utilize aspects of the modules described in U.S. Pat. Nos. 7,538,316; 7,446,650; 7,188,963; 7,004,593; 6,824,281; 6,774,356; 6,690,268; 6,250,148; 6,341,523; 6,593,565; 6,428,172; 6,501,387; 6,329,925; and 6,326,613, and/or in PCT Application No. PCT/US03/40611, filed Dec. 19, 2003 and published Jul. 15, 2004 as International Publication No. WO 2004/058540, and/or Ireland pat. applications, Ser. No. S2004/0614, filed Sep. 15, 2004; Ser. No. S2004/0838, filed Dec. 14, 2004; and Ser. No. S2004/0840, filed Dec. 15, 2004, which are all hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. An interior rearview mirror assembly for a vehicle, said interior rearview mirror assembly comprising:
a mirror head having a reflective element;
a mounting assembly for adjustably mounting said mirror head at an interior portion of a vehicle that is equipped with said mirror assembly;
wherein said mounting assembly comprises a mounting base that is attachable to an interior portion of the equipped vehicle and a mounting arm adjustably joined to said mounting base via a base pivot joint, and wherein said mirror head is pivotally adjustable relative to said mounting arm via a mirror pivot joint;
wherein said mounting arm comprises an arm portion and mirror ball portion that are unitarily formed of a metallic material;
wherein said mirror ball portion of said mounting arm is pivotally received at a socket element of said mirror head; and
wherein said mirror head and reflective element are adjustable about said base and mirror pivot joints to adjust a rearward field of view of a driver of a vehicle when said mirror assembly is normally mounted in the equipped vehicle.

2. The interior rearview mirror assembly of claim 1, wherein said mounting arm comprises a hollow arm portion that receives a ball member of said mounting base therein to pivotally attach said mounting arm at said mounting base.

3. The interior rearview mirror assembly of claim 1, wherein said mounting arm comprises a base ball portion at an end of said arm portion opposite said mirror ball portion, and wherein said base ball portion, said arm portion and said mirror ball portion are unitarily formed of said metallic material.

4. The interior rearview mirror assembly of claim 1, wherein said mounting arm is formed via a hydroforming process.

5. The interior rearview mirror assembly of claim 1, wherein said mounting arm comprises a computer numerically controlled spun metallic tube.

6. The interior rearview mirror assembly of claim 1, wherein said mounting arm comprises aluminum.

7. The interior rearview mirror assembly of claim 1, wherein said mounting arm comprises steel.

8. An interior rearview mirror assembly for a vehicle, said interior rearview mirror assembly comprising:
a mirror head having a reflective element;
a mounting assembly for adjustably mounting said mirror head at an interior portion of a vehicle that is equipped with said mirror assembly;
wherein said mounting assembly comprises a mounting base that is attachable to an interior portion of the equipped vehicle and a mounting arm adjustably joined to said mounting base via a base pivot joint, and wherein said mirror head is pivotally adjustable relative to said mounting arm via a mirror pivot joint;
wherein said mounting arm comprises an arm portion and a mirror ball portion that are unitarily formed of a metallic material;
wherein said mounting arm comprises one of (i) a computer numerically controlled spun metallic tube and (ii) a mounting arm formed via a hydroforming process;
wherein said mounting arm comprises a hollow arm portion that receives a ball member of said mounting base therein to pivotally attach said mounting arm at said mounting base;
wherein said mirror ball portion of said mounting arm is pivotally received at a socket element of said mirror head; and
wherein said mirror head and reflective element are adjustable about said base and mirror pivot joints to adjust a rearward field of view of a driver of a vehicle when said mirror assembly is normally mounted in the equipped vehicle.

9. The interior rearview mirror assembly of claim 8, wherein said mounting arm comprises aluminum.

10. The interior rearview mirror assembly of claim 8, wherein said mounting arm comprises steel.

11. The interior rearview mirror assembly of claim 8, wherein said mounting arm comprises a computer numerically controlled spun metallic tube.

12. The interior rearview mirror assembly of claim 8, wherein said mounting arm is formed via a hydroforming process.

13. A method of forming a mounting arm of a mounting assembly of an interior rearview mirror assembly for a vehicle, said method comprising:
forming a mounting arm comprising an arm portion and a mirror ball portion that are unitarily formed together;
wherein said mounting arm comprises a metallic material; and
wherein said mirror ball portion of said mounting arm is configured to be pivotally received at a socket element of the mirror head, and wherein said mounting arm is configured for pivotally mounting a mirror head at a mounting base that is attachable to an interior portion of a vehicle.

14. The method of claim 13, wherein said mounting arm comprises a hollow tubular arm portion.

15. The method of claim 14, wherein an end of said hollow tubular arm portion is configured to receive a ball member of the mounting base therein to pivotally attach said mounting arm at the mounting base.

16. The method of claim 13, wherein forming a mounting arm comprises forming a mounting arm that comprises a base ball portion at an end of said arm portion opposite said mirror ball portion, and wherein said base ball portion, said arm portion and said mirror ball portion are unitarily formed of said metallic material.

17. The method of claim 13, wherein forming a mounting arm comprises forming a mounting arm via a hydroforming process.

18. The method of claim 13, wherein forming a mounting arm comprises forming a mounting arm via a computer numerically controlled process to form a computer numerically controlled spun metallic tube.

19. The method of claim 13, wherein said mounting arm comprises aluminum.

20. The method of claim 13, wherein said mounting arm comprises steel.
